(19) United States
(12) Patent Application Publication
(10) Pub. No.: US 2024/0141073 A1
(43) Pub. Date: May 2, 2024

(54) METHOD FOR MANUFACTURING CELLULOSE DERIVATIVE

(71) Applicant: SEIKO EPSON CORPORATION, Tokyo (JP)

(72) Inventors: Yoshiki NAKASHIMA, Suwa (JP); Hideki TANAKA, Chino (JP); Sotaro OANA, Matsumoto (JP); Makoto KATO, Shiojiri (JP)

(21) Appl. No.: 18/494,749

(22) Filed: Oct. 25, 2023

(30) Foreign Application Priority Data
Oct. 27, 2022 (JP) 2022-172298

(51) Int. Cl. C08B 3/00

(52) U.S. Cl. CPC C08B 3/00

(57) ABSTRACT

A method for manufacturing a cellulose derivative includes a step of preparing a low crystalline cellulose having a degree of crystallinity of 70% or less and a step of derivatizing the low crystalline cellulose described above.

The present application is based on, and claims priority from JP Application Serial Number 2022-172298, filed Oct. 27, 2022, the disclosure of which is hereby incorporated by reference herein in its entirety.

### BACKGROUND

### 1. Technical Field

The present disclosure relates to a method for manufacturing a cellulose derivative.

### 2. Related Art

Since bioplastics formed using plants as a raw material are able to contribute to countermeasures against petroleum depletion and global warming, the use of the bioplastics has been studied not only for general products, such as packages, containers, and fibers, but also for durable products, such as electronic apparatuses and automobiles. As the raw materials for the bioplastics, cellulose which is a primary component of woods and plants is representative, and various types of bioplastics are now to be developed using the cellulose.

The cellulose is manufactured as pulp in a manner such that lignin and hemicellulose are chemically separated from woods and the like by a chemical reagent. In addition, since being almost formed from cellulose, cotton itself can be used as the cellulose. Although the cellulose as described above is a high molecular weight material formed by polymerization of β-glucose, since having a large number of hydroxy groups, the cellulose has a high intermolecular force by hydrogen bonds. Hence, the cellulose described above is hard and fragile and also has no thermoplasticity, and in addition, the cellulose has a low solubility in a solvent other than a particular solvent. Furthermore, since having a large number of hydroxy groups each functioning as a hydrophilic group, the cellulose has a high water absorbability and a low water resistance.

Accordingly, various modifications have been carried out on the cellulose. For example, JP-A-2010-121121 has disclosed a cellulose derivative in which at least some hydrogen atoms of hydroxy groups of cellulose are replaced by a short-chain acyl group (such as an aliphatic acyl group having 2 to 4 carbon atoms) and a long-chain acyl group (such as an aliphatic acyl group having 5 to 20 carbon atoms). The document described above has also disclosed that since having a low water absorption rate and preferable thermoplasticity, strength, and rupture elongation, this cellulose derivative is suitably used for molding process.

However, the chemical modification to be done on the cellulose requires a complicated process, and a long period of time is also required therefor. In addition, energy required for the modification is also high, and hence, the process cost to obtain a cellulose derivative cannot always be low. Furthermore, mechanical characteristics and durability (such as heat resistance and/or water resistance) of a cellulose derivative to be manufactured may be insufficient in some cases.

### SUMMARY

According to an aspect of the present disclosure, there is provided a method for manufacturing a cellulose derivative, the method comprising a step of preparing a low crystalline cellulose having a degree of crystallinity of 70% or less and a step of derivatizing the low crystalline cellulose described above.

### BRIEF DESCRIPTION OF THE DRAWINGS

FIG. 1 is a graph illustrating a measurement method of the degree of crystallinity of cellulose.

FIG. 2 shows X-ray diffraction (XRD) patterns of various types of celluloses.

FIG. 3 is a graph showing the change in Ds value with a derivatization time when celluloses having various degrees of crystallinity are used as starting materials.

FIG. 4 is a graph showing the change in Ds value with a derivatization time when celluloses having various degrees of crystallinity are used as starting materials.

### DESCRIPTION OF EXEMPLARY EMBODIMENTS

Hereinafter, embodiments of the present disclosure will be described. The following embodiments are to explain examples of the present disclosure. The present disclosure is not at all limited to the following embodiments and includes various types of modified and/or changed embodiments to be performed without departing from the scope of the present disclosure. In addition, all the constituents to be described below are not always required to be essential constituents of the present disclosure.

### 1. Method for Manufacturing Cellulose Derivative

A method for manufacturing a cellulose derivative according to this embodiment includes a step of preparing a low crystalline cellulose having a degree of crystallinity of 70% or less and a step of derivatizing the low crystalline cellulose described above.

### 1.1. Step of Preparing Low Crystalline Cellulose

A low crystalline cellulose can be manufactured in a manner such that the crystallinity of cellulose contained in woods and plants is decreased by applying a mechanical force thereto. A low crystalline cellulose can be obtained, for example, by destroying a crystalline structure of cellulose using a method, such as pulverization or defibration.

As a concrete method to decrease the crystallinity of cellulose, for example, there may be mentioned pulverization using a pulverizing machine, such as a ball mill, hammer mill, a pin mill, a cutter mill, a pulverizer, a turbo mill, a disc mill, a screen mill, or a jet mill, or defibration using a dry defibration machine.

In addition, the crystalline structure of cellulose indicates the structure in which hydroxy groups in cellulose molecules are aggregated to each other by hydrogen bonds. The hydrogen bonds as described above may be formed either in one cellulose molecule or between cellulose molecules different from each other. The crystalline structure of cellulose is different from an almost perfect crystalline structure of an inorganic compound or the like and has a relatively low regularity similar to that of a crystalline organic high molecular weight material, such as a polyethylene.

Since the mechanical force as described above is applied to cellulose, the regularity of the crystalline structure thereof is decreased, and as a result, the degree of crystallinity of the cellulose can be decreased.

The degree of crystallinity of cellulose can be measured by an X-ray diffraction method. FIG. 1 is a graph illustrating a measurement method of the degree of crystallinity of cellulose. In order to obtain the degree of crystallinity of cellulose, as shown in FIG. 1, by an X-ray diffraction method, an intensity I₁ of a peak derived from the (200) plane of cellulose and an intensity I₂ derived from an amorphous portion of the cellulose are obtained. A diffraction angle of the peak intensity I₁ derived from the (200) plane of the cellulose is approximately 23°. The intensity I₂ is an intensity of a tail of the peak derived from the (200) plane at a low diffraction angle side. In particular, the diffraction angle of the intensity I₂ is approximately 19°. In addition, from the intensity I₁ and the intensity I₂, the degree of crystallinity is obtained from the following equation (1) by Segal method.

Degree of crystallinity (%)=((I₁−I₂)/I₁)×100 (1)

The cellulose is a high molecular weight material in which β-glucose molecules are linearly polymerized with glycoside bonds therebetween. As long as including the cellulose units as described above, the cellulose may partially include a non-cellulose molecular structure, such as a branched structure.

As cellulose used as the raw material of the low crystalline cellulose, a cellulose derived from wood-based pulp is preferable. As the wood-based pulp, there may be mentioned virgin pulp, kraft pulp, bleached chemi-thermo mechanical pulp, synthetic pulp, or pulp derived from waste paper or the like. In the cellulose derived from wood-based pulp, lignin and hemicellulose may also be included.

An average fiber length of the cellulose used as the raw material of the low crystalline cellulose is, for example, 100 μm to 5 mm, preferably 120 μm to 4 mm, more preferably 140 μm to 3 mm, even more preferably 160 μm to 2 mm, and further preferably 180 μm to 1 mm. The “average fiber length” indicates a weight average fiber length.

In addition, an average fiber length of the low crystalline cellulose obtained after the treatment, such as pulverization, is preferably 6 μm to 500 μm, more preferably 10 to 400 μm, and further preferably 30 μm to 300 μm.

On the other hand, an average fiber width of the cellulose to be used as the raw material of the low crystalline cellulose is, for example, 5 μm to 50 μm, preferably 10 μm to 30 μm, more preferably 15 μm to 25 μm, and further preferably 17 μm to 23 μm. The “average fiber width” indicates a weight average fiber width. The fiber width indicates a length of cellulose orthogonal to the fiber length thereof. When the cross-section of cellulose is a circle, the fiber width can also be called a fiber diameter.

In addition, an average fiber width of the cellulose obtained after the treatment, such as pulverization, is for example, 5 μm to 50 μm, preferably 10 to 30 μm, more preferably 15 μm to 25 μm, and further preferably 17 μm to 23 μm.

The average fiber length and the average fiber width of cellulose can be measured in accordance with “JIS P 8226-2:2011” using a fiber tester or the like.

A ratio (aspect ratio) of the average fiber length to the average fiber width of cellulose is not particularly limited, and for example, the ratio described above is 5 to 250, preferably 6 to 200, more preferably 7 to 150, even more preferably 8 to 100, and further preferably 9 to 50.

In the method for manufacturing a cellulose derivative according to this embodiment, a low crystalline cellulose having a degree of crystallinity of 70% or less is prepared. That is, a cellulose having a degree of crystallinity of 70% or less obtained by a treatment, such as pulverization, is used. The degree of crystallinity of the low crystalline cellulose is preferably less than 66%, more preferably 60% or less, and further preferably 50% or less. A lower limit of the degree of crystallinity of the low crystalline cellulose is not particularly limited, and for example, the lower limit described above is 0% or more, preferably 10% or more, and more preferably 20% or more.

When the degree of crystallinity of the low crystalline cellulose is in the range described above, the regularity of the crystalline structure of the cellulose is low, or the packing force of the crystalline structure of the cellulose is weak. Accordingly, when the cellulose is derivatized, since a reaction liquid is likely to be brought into contact with hydroxy groups of the cellulose, a reaction efficiency is made preferable, and as a result, the derivatization step can be performed within a short time.

### 1.2. Step of Derivatizing Low Crystalline Cellulose

The method for manufacturing a cellulose derivative according to this embodiment includes a step of derivatizing the low crystalline cellulose described above.

The derivatization includes the case in which at least one hydrogen atom of hydroxy groups contained in the cellulose is replaced by an acyl group (alkanoyl group). In other words, the derivatization includes the case in which at least one hydroxy group contained in the cellulose is esterified. In addition, the derivatization may also include the case in which at least one hydroxy group contained in the cellulose is etherified.

In the method for manufacturing a cellulose derivative according to this embodiment, the derivatization is more preferably performed by esterification of at least one hydroxy group of the low crystalline cellulose. Accordingly, the cellulose derivative can be more efficiently manufactured.

The derivatization can be performed, for example, by a known method and can be performed such that the low crystalline cellulose is allowed to react with a halogenated carboxylic acid, such as a carboxylic acid chloride, or is allowed to react with a carboxylic acid compound.

As the carboxylic acid chloride used for the derivatization, in more particular, an alkylcarboxylic acid chloride may be mentioned (R¹—CO—Cl: although R¹ represents an alkyl group having 2 to 20 carbon atoms, as R¹—CO—, for example, there may be mentioned an acetyl group, a propionyl group, a butyryl group, a 2-methylbutyryl group, a 3-methylbutyryl group, an n-hexanoyl group, a 2-methylvaleryl group, a 2-ethylbutyryl group, 2-methylhexanoyl group, an n-octanoyl group, 2-ethylhexanoyl group, a 2-propylpentanoyl group, an n-dodecanoyl group, an n-lauroyl group, a 2-butyloctanoyl group, an n-myristoyl group, an n-palmitoyl group, a 2-hexyldecanoyl group, an n-stearoyl group, an isostearoyl group, or an n-arachinoyl group, and one selected from a 2-methylbutyryl group, a 3-methylbutyryl group, a 2-ethylbutyryl group, 2-ethylhexanoyl group, 2-propylpentanoyl group, a 2-hexyldecanoyl group, and an isostearoyl group is preferable).

In addition, as the carboxylic acid compound used for the derivatization, in more particular, there may be mentioned an organic monocarboxylic acid represented by R 2 —COOH (although representing an alkyl group having 2 to 20 carbon atoms, R² is preferably selected from the group consisting of a methyl group, an ethyl group, a propyl group, a butyl group, a pentyl group, a hexyl group, a methoxymethyl group, ethoxymethyl group, propoxymethyl group, butoxymethyl group, pentoxymethyl group, a hydroxymethyl group, and (2-propenyloxy)methyl group).

In the cellulose derivatized in this step, the number of hydroxy groups present before the derivatization is decreased. As an index to represent the rate of hydroxy groups esterified and/or etherified by the derivatization, a Ds value is defined. The Ds value represents the rate of the number of esterified or etherified hydroxy groups with respect to the three hydroxy groups present in one glucose unit forming the cellulose and is the average value of the entire cellulose molecule.

From a theoretical point of view, when all the hydroxy groups of the cellulose remain without the reaction, the Ds value is zero, that is, is the minimum, and when all the hydroxy groups of the cellulose are formed into other groups by the reaction, the Ds value is 3, that is, is the maximum.

When the Ds value is high, the cellulose derivative is believed to have a high flexibility. In addition, in this step, as the Ds value is increased, that is, as the reaction of hydroxy groups advances, the cellulose derivative is believed to be eluted into a reaction solution.

In addition, when remaining in the cellulose, the unreacted hydroxy groups can be confirmed by the presence of a peak derived from a hydroxy group of the cellulose using, besides an X-ray diffraction method, an infrared (IR) absorption spectroscopy.

The Ds value of the cellulose derivative derivatized in this step may be less than 3. Even by a cellulose derivative having a Ds value of less than 3, the crystallinity thereof is sufficiently low, and preferable thermoplasticity and biodegradability can be sufficiently obtained.

In addition, the Ds value of the cellulose derivative derivatized in this step may be 2.5 or less. As a result, within a shorter process time, a cellulose derivative having a low crystallinity and preferable thermoplasticity and biodegradability can be obtained.

In addition, when the Ds value of the cellulose derivative derivatized in this step is 1.5 or more, the crystallinity of the cellulose can be sufficiently decreased, and a cellulose derivative having preferable thermoplasticity and biodegradability can be obtained. However, a lower limit of the Ds value of the cellulose derivative derivatized in this step is more preferably 1.8 or more and further preferably 2.0 or more.

By the step described above, since the number of hydroxy groups of the cellulose is decreased, the regularity of the crystalline structure is decreased, or the packing force of the crystalline structure of the cellulose is weakened; hence, the degree of crystallinity of the cellulose is believed to be decreased.

### 1.3. Operational Effect and Application

The method for manufacturing a cellulose derivative according to this embodiment uses a low crystalline cellulose. Hence, a reaction rate of the derivatization is high. In addition, a cellulose derivative having a high degree of derivatization, a sufficiently low crystallinity, and preferable thermoplasticity and biodegradability can be obtained.

Since having a preferable thermoplasticity and a preferable environmental compatibility, such as biodegradability, the cellulose derivative obtained by the manufacturing method according to this embodiment can be applied, for example, to plastic molding. In addition, this cellulose derivative can also be used to be blended with another resin and the like. As a concrete example of a molded body using this cellulose derivative, for example, a housing of an electronic apparatus, such as a printer, may be mentioned.

### 2. Experimental Examples

Hereinafter, although the present disclosure will be further described with reference to experimental examples, the present disclosure is not at all limited thereto.

### 2.1. Preparation of Celluloses Having Different Degrees of Crystallinity

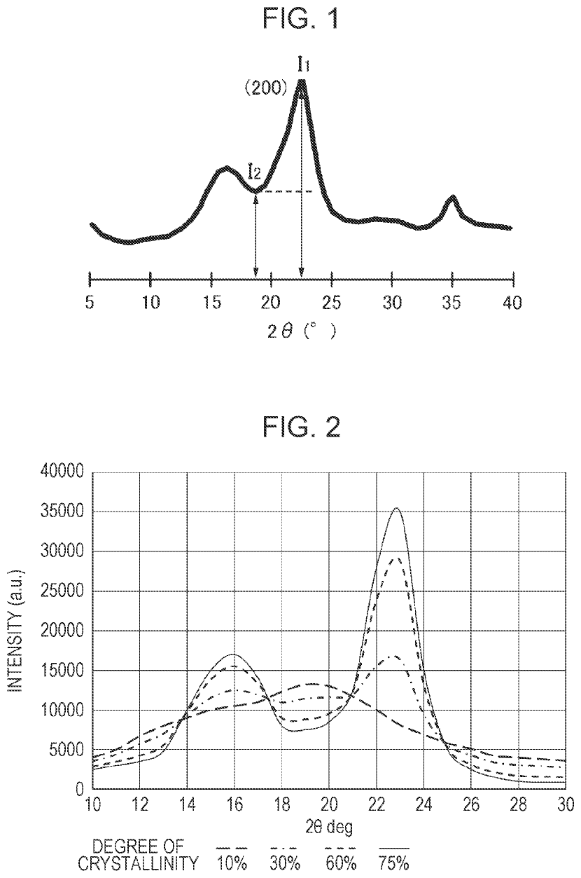

FIG. 2 shows X-ray diffraction (XRD) patterns of various types of celluloses. In FIG. 2, an XRD pattern of a raw material pulp (degree of crystallinity: 75%) and XRD patterns of pulps (degrees of crystallinity: 60%, 30%, and 10%) pulverized using a ball mill are shown. From those XRD patterns, the degree of crystallinity was calculated.

The degree of crystallinity of the pulp was adjusted by changing a pulverization time of a ball mill. The pulps having degrees of crystallinity of 60%, 30%, and 10% were pulverized approximately for 150 seconds, 350 seconds, and 500 seconds, respectively, using a ball mill.

### 2.2. Degree of Crystallinity and Derivatization Time

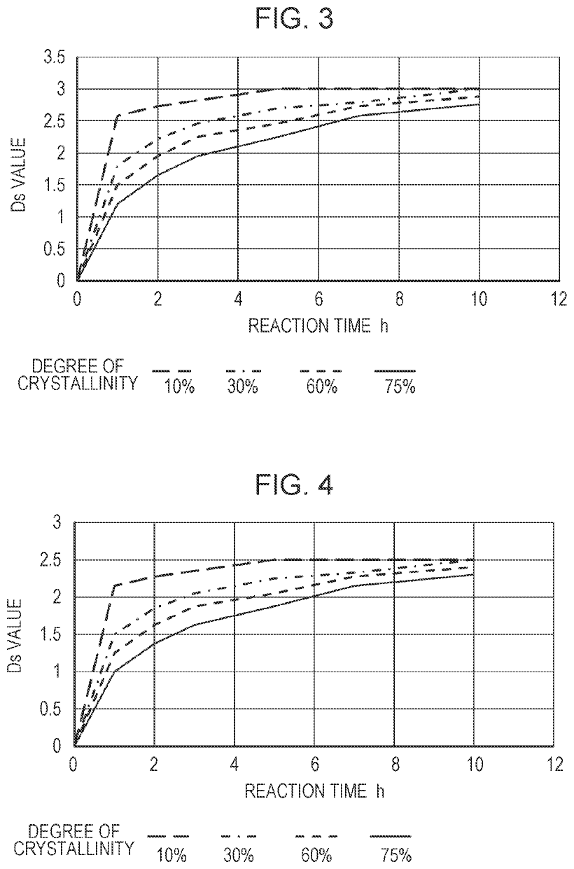

The influence of the degree of crystallinity of the cellulose used as a starting material for the derivatization on the time required for the derivatization was investigated. FIGS. 3 and 4 show the change in Ds value with the derivatization time when celluloses having various degrees of crystallinity are used as the starting materials.

FIG. 3 shows the results each of which was obtained in a manner such that after cellulose and propionyl chloride were charged at a molar ratio so as to obtain a Ds value of 3, a reaction was carried out. FIG. 4 shows the results each of which was obtained in a manner such that after cellulose and propionyl chloride were charged at a molar ratio so as to obtain a Ds value of 2.5, a reaction was carried out. In addition, as a reaction solvent, N-methyl pyrrolidone (NMP) was used, and the reaction was carried out such that after the cellulose was added to NMP and then heated to 50° C., propionyl chloride was dripped thereto while stirring was performed by a mechanical stirrer.

### 2.3. Evaluation of Result

From FIGS. 3 and 4, it was found that as the degree of crystallinity of the cellulose used for the derivatization is lower, an increase in Ds value occurs within a shorter time.

The embodiments described above are simply examples, and the present disclosure is not limited thereto. For example, the embodiments and modified examples may be appropriately used in combination.

The present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

From the embodiments and the modified examples described above, the following conclusions can be obtained.

A method for manufacturing a cellulose derivative, comprises a step of preparing a low crystalline cellulose having a degree of crystallinity of 70% or less and a step of derivatizing the low crystalline cellulose described above.

According to this method for manufacturing a cellulose derivative, since the low crystalline cellulose is used, the efficiency of the derivatization is preferable, and the derivatization step can be performed within a short time.

In the method for manufacturing a cellulose derivative described above, the degree of crystallinity of the low crystalline cellulose may also be less than 66%.

According to this method for manufacturing a cellulose derivative, the efficiency of the derivatization is more preferable, and the derivatization step can be performed within a shorter time.

In the method for manufacturing a cellulose derivative described above, the derivatization may be esterification of a hydroxy group of the low crystalline cellulose described above.

According to this method for manufacturing a cellulose derivative, the cellulose derivative can be more efficiently manufactured.

In the method for manufacturing a cellulose derivative described above, the low crystalline cellulose described above may have an average fiber length of 6 μm to 500 μm.

According to this method for manufacturing a cellulose derivative, the cellulose derivative can be further efficiently manufactured.

In the method for manufacturing a cellulose derivative described above, the cellulose derivative may have a Ds value of less than 3.

According to this method for manufacturing a cellulose derivative, a cellulose derivative having a sufficiently low crystallinity can be obtained, and the thermoplasticity and the biodegradability of this cellulose derivative can be improved.

In the method for manufacturing a cellulose derivative described above, the cellulose derivative may also have a Ds value of 2.5 or less.

According to this method for manufacturing a cellulose derivative, a cellulose derivative having a low crystallinity and preferable thermoplasticity and biodegradability can be obtained.

What is claimed is:

1. A method for manufacturing a cellulose derivative, comprising:
preparing a low crystalline cellulose having a degree of crystallinity of 70% or less; and
derivatizing the low crystalline cellulose.

2. The method for manufacturing a cellulose derivative according to claim 1,
wherein the degree of crystallinity of the low crystalline cellulose is less than 66%.

3. The method for manufacturing a cellulose derivative according to claim 1,
wherein the derivatization is esterification of a hydroxy group of the low crystalline cellulose.

4. The method for manufacturing a cellulose derivative according to claim 1,
wherein the low crystalline cellulose has an average fiber length of 6 μm to 500 μm.

5. The method for manufacturing a cellulose derivative according to claim 1,
wherein the cellulose derivative has a Ds value of less than 3.

6. The method for manufacturing a cellulose derivative according to claim 1,
wherein the cellulose derivative has a Ds value of 2.5 or less.
